(19) United States
(12) Patent Application Publication
(10) Pub. No.: US 2002/0069188 A1
(43) Pub. Date: Jun. 6, 2002

(54) On-line payment settlement for multi-party based services

(75) Inventors: Dinesh Kashinath Anvekar, Piscataway, NJ (US); Bhaskarpillai Gopinath, Watchung, NJ (US); Rajiv Mangla, New Delhi (IN); Sridhar Sundaram, Highland Park, NJ (US)

Correspondence Address: MOSER, PATTERSON & SHERIDAN L.L.P., 595 SHREWSBURY AVE, FIRST FLOOR, SHREWSBURY, NJ, 07702, US

(73) Assignee: Level Z, L.L.C.

(21) Appl. No.: 09/728,591

(22) Filed: Dec. 1, 2000

(51) Int. Cl. G01R 11/56; G06F 17/60; G06F 17/00; H04L 9/00; H04K 1/00; G01R 21/133

(52) U.S. Cl. 705/412; 705/64; 705/68; 705/78

(57) ABSTRACT

A system and method for identifying each of a plurality of service providers cooperating to provide a service to a customer wherein a fee debited from a stored value account associated with the customer is apportioned among the cooperating service providers according to a measurement of the provided service portions.

### FIELD OF THE INVENTION

The present invention relates to the field of stored value commerce systems and, more particularly, to a stored value commerce system capable of providing payment settlements for services rendered by one or more service providers on behalf of an authorized user of a stored value account.

### BACKGROUND OF THE INVENTION

In multi-party based service systems, a consumer receives a requested service provided by a plurality of service providers working together, either directly or indirectly. For example, in telephony services a local telephone company may provide access to a switch while an intra-lata and/or long distance carrier and/or Internet Service Provider (ISP) may be used to provide voice, data services.

In existing multi-party based service systems, payment settlements are often made long after the time that the service is actually rendered. This results in a floating of the pending amounts due to service providers (i.e., floating accounts receivables). Also, settlements based on individual service portions provided by service providers may lead to conflicting settlement decisions with respect to the entirety of the provided service. That is, in the case of a plurality of service providers operating in a directly or indirectly cooperative manner to provide a service to a customer, disagreements as to the value of the incremental services or service portions provided to the customer by individual service providers may arise. Such disagreements may be the result of inconsistencies in government tariff structures, differences between rate plans (fixed price, free or discounted minutes and other incentive programs when unevenly applied and the like), currency fluctuations and other technical or business factors.

### SUMMARY OF THE INVENTION

These and other limitations associated with the prior art are overcome by the present invention of a system and method for on-line settlement of amounts due to different service providers proximate the time services are rendered. Settlement is effected via a service measurement and settlement agent (SMSA) that meters the requested and rendered services, apportions the total cost of provided services among the various service providers in accordance with service level agreements (SLAs) and settles the provided service bill by utilizing stored value accounts associated with a customer or customers and the individual service providers.

A settlement method according to an embodiment of the invention comprises the steps of identifying each of a plurality of service providers operating to provide a service to at least one user in exchange for a fee debited from an account associated with the at least one user; apportioning the fee to the identified service providers; and crediting respective service provider accounts with respective portions of the fee.

### BRIEF DESCRIPTION OF THE DRAWINGS

A more complete understanding of the present invention may be obtained from consideration of the following description in conjunction with the drawings in which:

FIG. 1 is a block diagram of an exemplary embodiment of a multi-vendor service providing a settlement system;

FIG. 2 is a block diagram of an exemplary embodiment of a service measurement and settlement agent (SMSA) suitable for use in the system of FIG. 1;

FIG. 3 is a flow diagram of a method according to the present invention; and

FIG. 4 depicts a graphical representation of customer and service provider relationships useful in understanding the present invention.

To facilitate understanding, identical reference numerals have been used, where possible, to designate identical elements that are common to the figures.

### DETAILED DESCRIPTION

The present invention will be described within the context of a service measurement and settlement agent that meters the use of services by a customer utilizing a plurality of services and rapidly settles charges stemming from the provided services using a stored value provider.

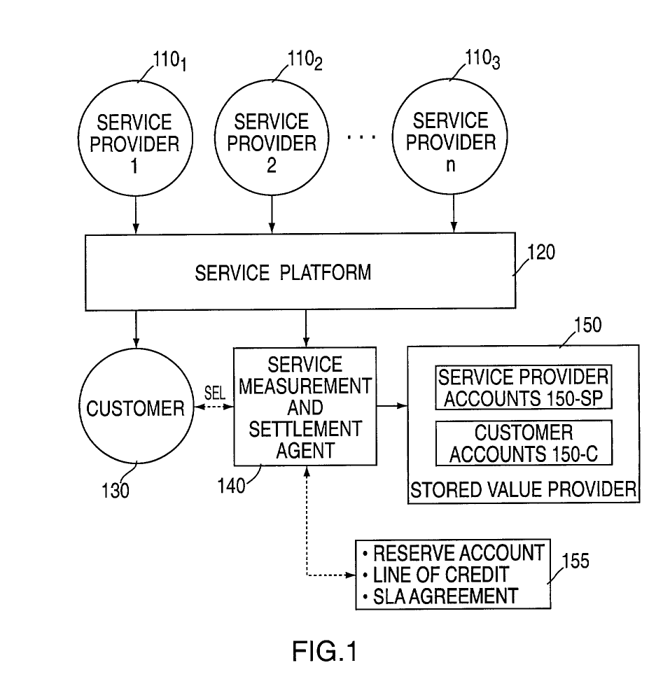

FIG. 1 is a block diagram of an exemplary embodiment of a multi-vendor service providing system and associated settlement system. Specifically, the system 100 of FIG. 1 comprises a plurality of service providers 110₁, 110₂ and so on up to 110ₙ (collectively service providers 110), a service platform 120, a customer 130, a service measurement and settlement agent (SMSA) 140 and a stored value provider 150. The system may be scaled to provide for many customers, service providers and service platforms.

The customer 130 accesses, via the service platform 120, one or more of the services offered by the various service providers 110. For example, a telephone calling card service may be provided whereby one service provider supports call switching and management functions, while another service provider operates the telephone lines connecting the customer to a local switch. For every call in this system, proportionate amounts need to be paid to the two parties involved in providing the service. In this instance, the service platform 120 comprises the public switched telephone network (PSTN) or other communications network.

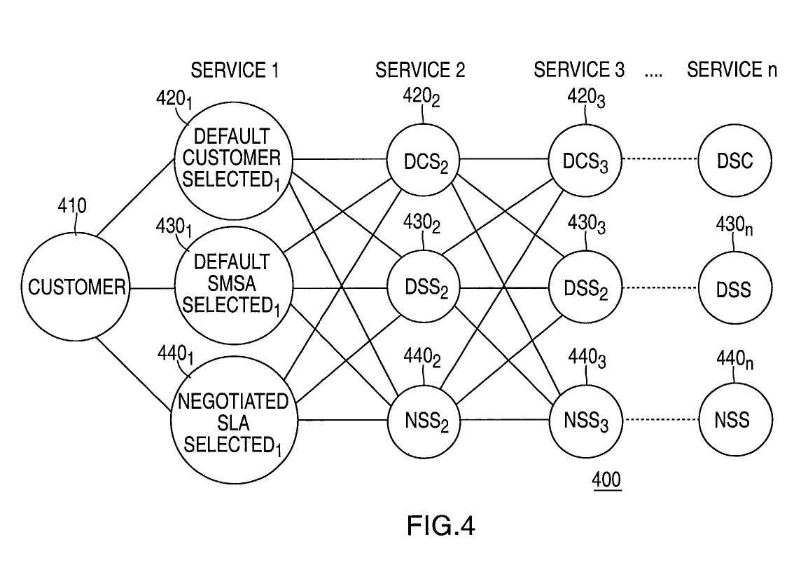

In general, as shown in FIG. 1, several service providers 110 may be involved in providing a service to a customer. Moreover, depending upon the particular service requested by the customer, different service providers may be selected by the customer based upon preexisting contractual arrangements, rapid calculation of least cost service provision and other factors, which will be discussed in more detail below with respect to FIG. 4.

Each of the service providers 110, as well as the customer 130, have respective accounts 150-SP and 150-C with the stored value provider 150 suitable for use in effecting on-line settlement of invoices related to acquired services.

Optionally, the SMSA 140 cooperates with alternate sources of value suitable for use in effecting a service transaction, as shown in box 155. Specifically, box 155 represents reserve account information, line of credit information, service level agreement information, and other information suitable for use in selecting, compensating for or otherwise effecting a service transaction. The items denoted in box 155 provide primary and/or reserve compensation means for use in the event of, for example, insufficient value within a primary compensation vehicle such as a stored value account within the stored value provider 150.

The service measurement and settlement agent (SMSA) 140 interacts with the service platform 120 to monitor the services, or service portions, provided by the service providers 110. The SMSA may also measure the services consumed by the customer 130. That is, in the case of a customer 130 requesting a service requiring the participation of multiple service providers 110, the service platform 120 facilitates the providing of the combined service to the customer, while providing to the SMSA data associated with the provided services.

The SMSA performs service related measurements and provides the results to the stored value provider 150. The service measurements involve at least those parameters affecting cost, such as service duration, quality of service, service interruption, type of service and the like. Additionally, currency fluctuations are monitored to provide substantially real-time cost accounting. Payment settlements are made based on the service measurements of the provided service and the service level agreements between the customer and the service providers.

It will be appreciated that the service platform 120 may be adapted to the particular service or services provided to a customer. For example, telecom services may be readily provided using a communications service platform comprising the PSTN or other telecommunications bridge service, proprietary communications networks, the Internet or other wired or wireless platforms, or combinations of platforms suitable for providing desired services. Video-on-demand systems may utilize similar communications platforms and/or cable television distribution networks. Other service platforms may be used to distribute other products and/or services. In the case of providing basic utilities for customers, the service platform 120 may also include various energy distribution networks, such as natural gas, electrical, water and other distribution networks.

Generally, the delivery of any service desired by a customer, which service is provided by the cooperative efforts of a plurality of service providers, may benefit from the teachings of the present invention. All that is required is that the service measurement and settlement agent is able to meter to provide its services in a meaningful way such that the fee for the provided service may be appropriately apportioned, and that the SMSA has knowledge of accounts associated with the service providers and customers such that settlement may be effected.

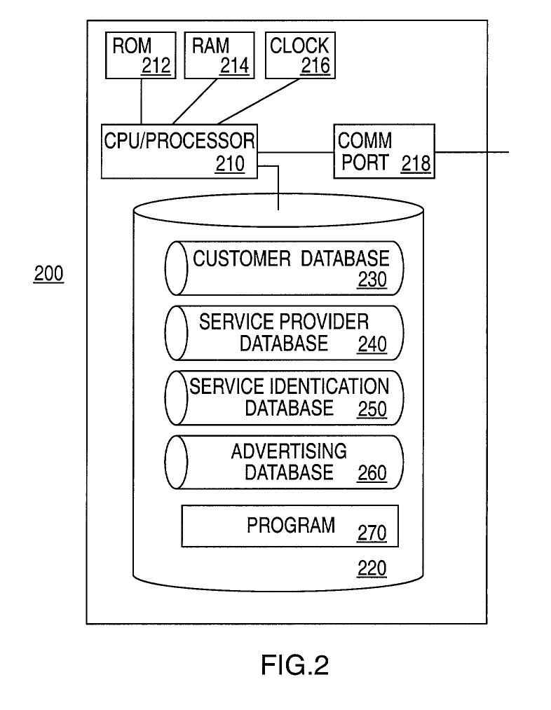

FIG. 2 is a block diagram of an exemplary embodiment of a service measurement and settlement agent suitable for use in the system of FIG. 1. The SVCP 200 preferably includes certain standard hardware components, such as a Central Processing Unit (CPU) 210, a data storage device 220, a read-only memory (ROM) 212, a random access memory (RAM) 214, a clock 216 and a communications port 218. The CPU 210 is preferably linked to each of the other listed elements, either by means of a shared data bus, or dedicated connections, as shown in FIG. 2. The CPU 210 may be embodied as a single processor, or a number of processors operating in conjunction with one another. The data storage device 220 and/or a ROM 212 are operable to store one or more instructions which the CPU 210 is operable to retrieve, interpret and execute. The CPU 210 preferably includes a control unit, an Arithmetic Logic Unit (ALU) and a CPU local memory storage device, such as, for example, a stackable cache or a plurality of registers, in a known manner. The control unit is operable to retrieve instructions from the data storage device 220 of ROM 212. The ALU is operable to perform a plurality of operations needed to carry out instructions. The CPU local memory storage device is operable to provide high speed storage used for storing temporary results and control information.

The data storage device 220 typically includes one or more machine readable media; such media includes, as is well known in the art, magnetic, semi-conductor and/or optical media. Data storage device 220 is preferably capable of supporting the searching and storing of data. Data storage device 220, or portions thereof, may reside on a single computer or server, or may be distributed in a known manner among a plurality of computers or servers.

The data storage device 220 preferably includes a customer database 230, a service provider database 240, a service identification database 250 as well as other applications code and programs 270 resident at the data storage device 220. The customer database 230 preferably includes customer specific data pertaining to customer service preferences, stored value account identities and other account identities. The service provider database 240 preferably includes service provider specific data pertaining to service provider rates, capabilities, preferences and accounts. The service identification database 250 preferably includes service specific data pertaining to the various systems employed to render a service. The advertising database 260 preferably includes advertising information such as audio or video streams provided to customers prior to a service (e.g., during service set-up). The communications port 218 connects the SMSA 200 to the other functional elements that interact with the SMSA 140, as previously described above with respect to FIG. 1.

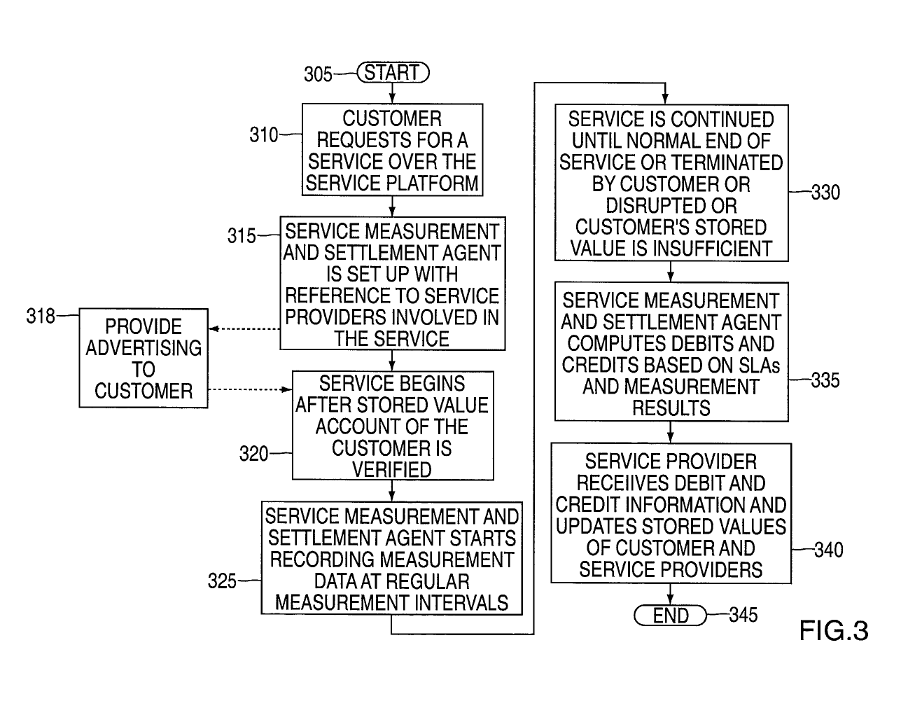

FIG. 3 comprises a flow diagram of a method according to the present invention. The settlement process begins at step 310 when a customer requests that a service be provided via the service platform.

At step 315, the service measurement and settlement agent (SMSA) receives information useful in defining the requested service, the service providers that will be providing the requested service, and the account numbers of the service providers and customer. The SMSA may coordinate specific service provider usage with the service platform.

At optional step 318, advertising information such as audio, video, textual, graphical or other information is provided to the customer. For example, in one embodiment of the invention, a customer receiving one or more advertisements also receives a fee reduction or service enhancement for at least a portion of the service provided by at least one service provider. For example, in a telephony application, a user may be provided with advertising from particular service providers, such as long distance carriers, interested in attracting new customers into service level agreements. Optionally, a customer may opt out of the advertisement by indicating such desire by, for example, pressing the “#” key on a telephone or other service access device.

At step 320, the stored value account (and whether sufficient value exists) of the customer is verified and the SMSA allows the service to begin. Alternatively, the service providers may begin to provide the service without waiting for verification of the stored value account of the customer. For example, where the customer has service level agreements (SLAs) in place with each of the service providers to be used defining alternate payment terms, the SMSA may allow the providing of services to proceed. In this embodiment, the SMSA serves to measure and apprise each service provider of the appropriate amount due. The amounts due from the customer are then collected by the service providers according to the terms of their respective agreements.

At step 325, the SMSA begins measuring, or receiving data indicative of customer usage of the various services provided by the service providers. The measured or received data may be periodic in nature, continuous or in any other form suitable for measuring consumption of services and service portions by the customer.

At step 330, the service is terminated due to a normal end of service condition, a customer termination of service or a determination by the SMSA that the customer's stored value account does not contain sufficient value to continue paying for the service. A normal termination of service may comprise the reception by the customer of the entirety of requested content within a video on demand (VOD) system or other case where the requested service has been fully delivered. Customer termination may comprise, for example, termination of a telephone call or other communciation.

In the case of insufficient stored value, the SMSA may alert a customer to a pending condition of insufficient stored value such that the customer may make payment (e.g., via a credit card or other account) prior to the existence of an insufficient value condition. Alternatively, in the case of insufficient value in a stored value account, the SMSA may access a reserve account associated with the customer, a line of credit associated with the customer (e.g., from a financial institution associated with the customer or the SMSA) or per terms within the service level agreement associated with the service providers 110 providing the requested service. Any combination of these alternative payment mechanisms may also be used, such as an SMSA line of credit being applied to the charges of a first service provider, while a second and third service provider effecting a requested service accept payments at a future date (i.e., extend credit to the customer).

It is noted that the SMSA provides means for facilitating substantially immediate payment to service providers in exchange for services rendered to the customer. The SMSA is also useful in precisely metering the services provided and determining the appropriate settlement amounts for the various service providers. In this manner, the SMSA may provide immediate settlement where a customer's account with a stored value provider has sufficient value, or may provide an immediate determination of appropriate settlement amounts where a future settlement is contemplated by the SLA between a customer and one or more service providers.

At step 335, the service measurement and settlement agent computes debits and credits based on SLAs and/or measurement results. That is, the SMSA computes debits and credits between the customer and service providers and between the various service providers themselves, for the measured service utilized by the customer. The settlement agent may include currency variation or fluctuation data within this calculation as an average exchange rate over the duration of the provided service or an exchange rate fixed at, for example, the start, end or middle of the service duration.

At step 340, the service providers each receive debit and credit information relating to the provided services. That is, the total value owed by the customer is debited from the stored value counter associated with the customer, apportioned and credited to the stored value accounts associated with the respective service providers according to the computation of step 335. The customer and service providers are apprised of any modifications to their respective account balances. The debit and/or credit information may be associated with a unique service identifier such that the type of service provided and the related cost structure may be appropriately tracked. That is, the service ID has associated with it service type (e.g., telephony), service cost (e.g., Rate Plan XYZ defining a rate agreement) and other service related data. The above described method 300 provides a means of rapidly determining and settling costs incurred by a customer in receiving a service provided by a plurality of service providers. In this manner, the service providers advantageously receive rapid payment, or at least payment in accordance with the service level agreements negotiated with the customer. Additionally, the customer is able to adapt, using the service level agreements and other mechanisms, the particular service providers used, the terms under which the individual services are provided and purchased, and other factors.

It will be appreciated by those skilled in the art that the above-described steps forming the method 300 of FIG. 3 may be performed in a different order, or may be performed simultaneously. For example, steps 325, 330 and 335 may be performed simultaneously such that service portion measurement data is continually retrieved (per step 325) and used to compute debits and credits (per step 335) until such time as the service is terminated (per step 330). In this manner, the SMSA may determine that an account associated with the customer or user has insufficient value to continue service at a present level beyond some period of time, thus enabling the SMSA to secure alternate payment means or a replenishment of the customer account by the customer.

It is also noted that, depending upon the service provided, service providers may be changed at any time. Thus, the various steps within the method 300 of FIG. 3 adapt to a change in the provider of any service portion. In the case of a change in service providers, the service provider whose services have been terminated may be credited immediately based upon measured services rendered, or may be credited with other service providers at the termination of the entire service provided to the customer.

It is also noted that a plurality of users may receive a single service. In this case, one user may be designated as a prime user or customer, such that that user or customer pays for the entire service. Alternatively, the service fee may be allocated among each of the plurality of users according to the proportional cost of providing service to each user. In this case, it is appropriate for each user to have an associated account in the stored value provider, or access to a common account as authorized users of the common account.

In a video-on-demand (VOD) service example, a video content service provider processes requests for content received via, for example, a telephone network; a telecom service provider handles customer calls and directs the orders to the video content provider; and a cable TV network operator supports the delivery of video programs to the customer's premises. In this example, the video content provider, telecom service provider and cable TV network operator are the three service providers involved in providing the video-on-demand service.

In one embodiment of the invention, unbundled utility services are provided to customers. That is, in the case of electrical services, natural gas services, telephony services, or generally any energy service or other service where the generation or production of a resource is provided by a first service provider, the distribution of the generated or provided resource is provided by one or more other service providers, the final delivery of the resource may be provided by yet another service provider. In each of these instances, where for each step in the service procurement process a plurality of service providers exists, a customer may have negotiated, via respective service level agreements, specific arrangements with the various service providers.

In one embodiment of the invention, the service measurement and settlement agent processes customer service requests and determines the least cost manner in which such request is satisfied. Thus, the SMSA selects the appropriate service providers based upon a least cost analysis of the customer service request and operates thereby as a service integrator. The SMSA meters and performs account crediting and debiting as discussed above with respect to FIG. 3.

FIG. 4 depicts a graphical representation of customer and service provider relationships useful in understanding the present invention. Specifically, FIG. 4 depicts a graphical representation 400 of service provider selection paths wherein N service portions are used to provide a service to a customer 410. For each of the N service portions required, the customer 410 may utilize a default customer selected service provider 420, a default SMSA selected service provider 430 or a negotiated SLA selected service provider 440. Thus, referring to FIG. 4, each of the services 1 through N may be rendered by default customer selected service providers 420₁ through 420_{N} (collectively default customer selected service providers 420), default SMSA selected service providers 430₁ through 430_{N} (collectively default SMSA selected service providers 430) and negotiated SLA selected service providers 440₁ through 440_{N} (collectively negotiated SLA service providers 440). As noted by the interconnecting paths depicted in FIG. 4, for each service provided, any one of the three types of service providers may be used.

The default customer selected service provider 420 comprises the default service provider for a particular service as used by the customer 410. The default customer selected service provider 420 may also comprise the geographically local service provider (e.g., the local telephone company for switching services) or sole service provider with respect to the customer 410.

The default SMSA selected service provider 430 comprises the default service provider for a particular service as used by the SMSA. This service provider may be selected by the SMSA due to a low cost analysis performed on behalf of the customer or on behalf of the SMSA, a service provider selected by the SMSA due to agreements between the SMSA and the service provider selected, or other service provider selected by the SMSA rather than by the customer.

The negotiated service level agreement (SLA) service provider 440 comprises the service provider having an agreement with the customer 410 regarding, for example, service rates, deliverables, usage times, quality of service and other parameters related to the delivery of a particular service (e.g., telephony, VOD, natural gas, electricity, water and other services).

In another embodiment, the SMSA preferentially utilizes service providers in exchange for fees and, optionally, in the absence of customer requests for specific service providers. In this embodiment of the invention, the SMSA operates to benefit those service providers who have achieved a preferential status with the SMSA due to, for example, the payment of a fee, the rapid adaptation of the SMSA system to their business model, the volume of business they do with the SMSA and other factors.

In one embodiment, the SMSA 140 operates as a service procurement agent on behalf of the customer 130. In this embodiment of the invention, the SMSA identifies all of the service providers capable of providing respective service portions suitable for effecting the desired service. The SMSA then performs an analysis of existing service license agreements in place between the customer and the various service providers, between the SMSA and the various service providers, as well as an analysis of cost structures of the various service providers. Sole source service providers are included. Given this cost analysis, a least cost solution is determined on behalf of the customer, and service providers are selected according to the least cost solution.

In one embodiment, the SMSA operates as a service promotion agent. In this embodiment, the SMSA, absent a contrary customer request, selects service providers to provide various service portions based upon the relationships of the service providers to the SMSA. These relationships may be financial arrangements based on, for example, the payment of fees by the service providers to the SMSA. Other SMSA promotional activities may also be defined.

The SMSA may procure from the customers (or service providers) a fee for this service aggregation, thus becoming, in effect, an additional service provider.

Although various embodiments which incorporate the teachings of the present invention have been shown and described in detail herein, those skilled in the art can readily devise many other varied embodiments that still incorporate these teachings.

What is claimed is:

1. A settlement method, comprising:
identifying each of a plurality of service providers operating to provide a service to a user in exchange for a fee debited from an account associated with said user;
apportioning said fee to said identified service providers; and
crediting respective service provider accounts with respective portions of said fee.

2. The method of claim 1, wherein said step of apportioning is adapted in response to changes in said provided service.

3. The method of claim 1, wherein said service comprises a telecommunications service supported by a plurality of service providers.

4. The method of claim 3, wherein said service includes a bridge service provided by a telecom platform service provider.

5. The method of claim 4, wherein said service includes a bridge service provided by an internet service provider.

6. The method of claim 1, wherein said service comprises a video-on-demand (VOD) service.

7. The method of claim 6, wherein said service includes services associated with content request and services associated with content delivery.

8. The method of claim 1, wherein said service comprises one of the delivery of electricity, natural gas and water.

9. The method of claim 8, wherein said delivery service includes services provided by source and distribution service providers.

10. The method of claim 1, wherein portions of said fee are debited from respective accounts associated with more than one user.

11. The method of claim 1, wherein said service is provided to a plurality of users, and wherein said service fee is allocated among said plurality of users according to the proportional cost of providing said service to each user.

12. The method of claim 1, wherein said service is provided to a plurality of users, and wherein said service fee is allocated among said plurality of users according to a least cost determination based on service level agreements between at least one of said users and said service providers.

13. The method of claim 11, wherein at least one of said plurality of users does not contribute to said service fee.

14. The method of claim 1, wherein at least one of said service providers is selected according to a service level agreement (SLA) between said at least one service provider and said user.

15. The method of claim 1, wherein said step of apportioning comprises the steps of:
measuring services provided to said user by said service providers; and
determining, for each of said measured services, a portion of said fee associated with said measured services.

16. The method of claim 1, further comprising:
selecting each of said plurality of service providers to provide said service to said user.

17. The method of claim 16, wherein those service providers having service level agreements with said user are selected to provide respective service portions.

18. The method of claim 16, wherein those service providers operating together to provide a lowest total cost for said service are selected.

19. The method of claim 1, further comprising:
monitoring said services provided to said user;
determining whether a value of said user account is sufficient to pay a presently accrued fee; and
in the case of said account value being insufficient, terminating said service to said user.

20. The method of claim 19, further comprising:
prior to said service termination, offering said user an opportunity to provide additional value such that said provided service may be continued.

21. The method of claim 1, further comprising:
monitoring said services provided to said user;
determining whether a value of said user account is sufficient to pay a presently accrued fee; and
in the case of said account value being insufficient, retrieving value from an alternate account associated with said user.

22. A computer readable medium having computer executable instructions for performing steps, comprising:
identifying each of a plurality of service providers operating to provide a service to a user in exchange for a fee debited from an account associated with said user;
apportioning said fee to said identified service providers; and
crediting respective service provider accounts with respective portions of said fee.

23. A system, comprising:
a service platform, for providing a service to a customer using a plurality of service providers;
a service measurement and settlement agent (SMSA), for measuring portions of said provided service associated with respective service providers, apportioning a fee to each of said service providers and crediting respective service provider accounts with respective portions of said fee.

24. The system of claim 23, wherein said SMSA operates to select service providers used to provide said service to said customer.

25. The system of claim 24, wherein said SMSA selects those service providers which together provide said service at a lowest cost to said customer.

26. The system of claim 24, wherein said SMSA selects service providers based upon payments made to said SMSA.

27. The system of claim 24, wherein said SMSA selects service providers based upon service level agreements between said customer and said selected service providers.
